(19) United States
(12) Patent Application Publication
(10) Pub. No.: US 2017/0351300 A1
(43) Pub. Date: Dec. 7, 2017

(54) ATTACHABLE TOUCH SCREEN PANEL BEZEL WITH USB CHIPSET STORAGE

(71) Applicant: Gary Douglas MUNDRAKE, Centerville, MD (US)

(72) Inventor: Gary Douglas MUNDRAKE, Centerville, MD (US)

(21) Appl. No.: 15/176,088

(22) Filed: Jun. 7, 2016

(51) Int. Cl. G06F 1/16; G06F 3/044

(52) U.S. Cl. CPC G06F 1/1632; G06F 1/1607; G06F 3/044

(57) ABSTRACT

A touchscreen panel bezel and method comprises a frame configured to an attached projected capacitive (PCAP) touchscreen panel. One or more clamp brackets are configured to secure a monitor within the frame. A first one of said clamp brackets is configured to receive and secure a universal serial bus (USB) controller. A ribbon slot disposed within the frame is configured to thread a ribbon of the PCAP touchscreen panel for attachment to the USB controller. A USB cable is for attachment to the USB controller and a processer external to the bezel.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This invention generally relates to an attachable touch screen panel. More specifically, the present invention relates to a system and method for an attachable touch screen panel bezel with universal serial bus (USB) chipset storage.

### SUMMARY OF THE INVENTION

According to one preferred embodiment, a touchscreen panel bezel, comprises: a frame configured to attached projected capacitive (PCAP) touchscreen panel; one or more clamp brackets configured to secure a monitor within the frame; a first one of said clamp brackets configured to receive and secure a universal serial bus (USB) controller; a ribbon slot disposed within the frame configured to thread a ribbon of the PCAP touchscreen panel for attachment to the USB controller; and a USB cable for attachment to the USB controller and a processer external to the bezel.

According to another preferred embodiment, a method for providing a touchscreen panel bezel comprises: attaching a projected capacitive (PCAP) touchscreen panel to frame; securing one or more clamp brackets to the frame; securing a universal serial bus (USB) controller to a first one of said clamp brackets; treading a ribbon of the PCAP touchscreen through a slot disposed within the frame; attaching the ribbon to the USB controller; and attaching a USB cable to the USB controller and a processer external to the bezel.

### BRIEF DESCRIPTION OF THE DRAWINGS

FIG. 1 is an exemplary bezel projected capacitive (PCAP) touchscreen assembly flow diagram;

FIG. 2 is a diagrammatic representation of the assembled bezel, PCAP and monitor according to the embodiment of FIG. 1;

FIG. 3 is a diagram that illustrates the configuration of the touch glass being attached to the bezel according to the embodiment of FIGS. 1 and 2;

FIG. 4 is a diagram that illustrates a rear view of the frame with the PCAP touch glass having been attached to the frame of the bezel according to the embodiment of FIGS. 1-3;

FIG. 5 is a diagram that illustrates another rear view of the frame with the chipset inserted and attached into the cradle according to the embodiment of FIGS. 1-4;

FIG. 6 is a diagram that illustrates a close up view of the chipset attached to the ribbon according to the embodiment of FIGS. 1-5;

FIG. 7 is a bottom perspective view of the clamp bracket with the USB cable attached to the chipset according to the embodiment of FIGS. 1-6; and

FIG. 8, is a rear perspective view of the complete assembly of the bezel, with side clamps, bottom clamp, and the clamp bracket enclosing the monitor according to the embodiment of FIGS. 1-7.

### DETAILED DESCRIPTION OF THE PREFERRED EMBODIMENTS

For the purpose of illustrating the invention, there is shown in the accompanying drawings several embodiments of the invention. However, it should be understood by those of ordinary skill in the art that the invention is not limited to the precise arrangements and instrumentalities shown therein and described below.

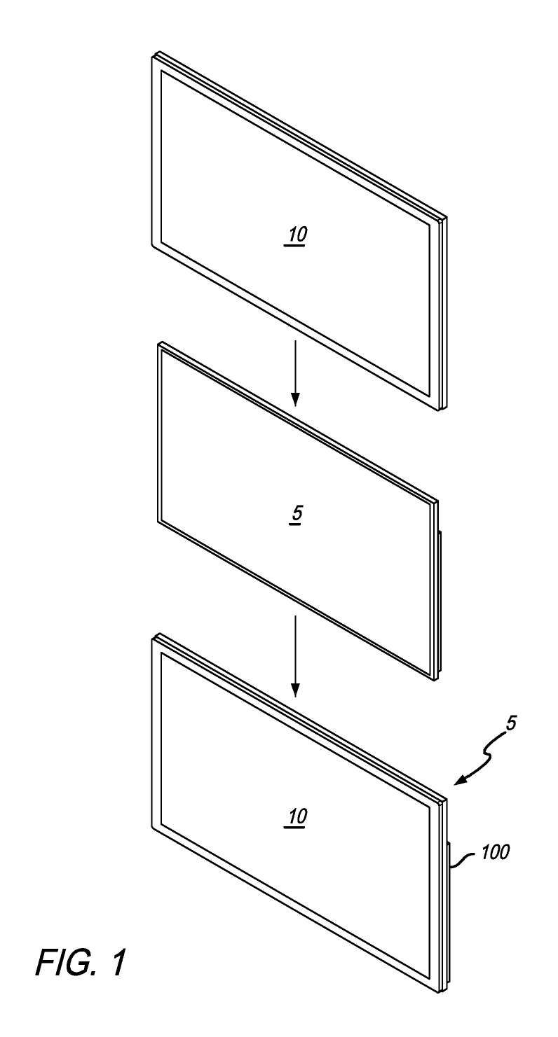

The method and system for an attachable touch screen panel bezel with universal serial bus (USB) chipset storage is disclosed in accordance with preferred embodiments of the present invention and is illustrated in FIGS. 1-8 wherein like reference numerals are used throughout to designate like elements.

The overlay bezel assembly is shipped to the end user with an installation guide instructing said user to remove the bottom clamp bracket only. Once bottom clamp bracket is removed, the assembly is placed over the monitor and the clamp bracket re-attached. This is unique, in that other integration companies integrate the touch onto the monitor. The overlay assembly described herein allows the end user to add the touch to their existing monitor.

In one embodiment, this PCAP overlay bezel comprises a rectangular bezel (to encase the monitor), welded to an inverted bezel (encasing the PCAP touch glass), with top and bottom monitor clamp brackets, and universal side brackets. A special slot is manufactured into the bezel and inverted bezel for the PCAP controller board or chip set ribbons to pass through to the back without visual detection.

In one embodiment, the apparatus integrates the PCAP to the inverted bezel with 3M VHB double sided tape. On the inside of the rectangular bezel, ⅛″ thick 3M foam tape is applied. The universal spacer brackets and the monitor clamp brackets may be attached using 6-32×¼ undercut flathead Phillips machine screws.

With reference to FIG. 1, an exemplary bezel projected capacitive (PCAP) touchscreen assembly flow diagram is shown according to one embodiment. A projective capacitive (PCAP) touch glass 10 is a commercially available product that provides a means for assembling touch screen monitors for human interface device (HID) compliant touch applications, making the mouse obsolete. Some of the manufacturers of PCAP are 3M®, Touch Expert® and IDS®. One PCAP touch glass 10 that may be used comprises part number 98-1100-0693-3 available from 3M Touch Systems. The PCAP touch glass 10 is placed over a non-touch screen monitor 5 by means of a bezel 100 that provides a ridge on which the touch glass 10 may be attached or taped, and to which the monitor 5 is attached or placed.

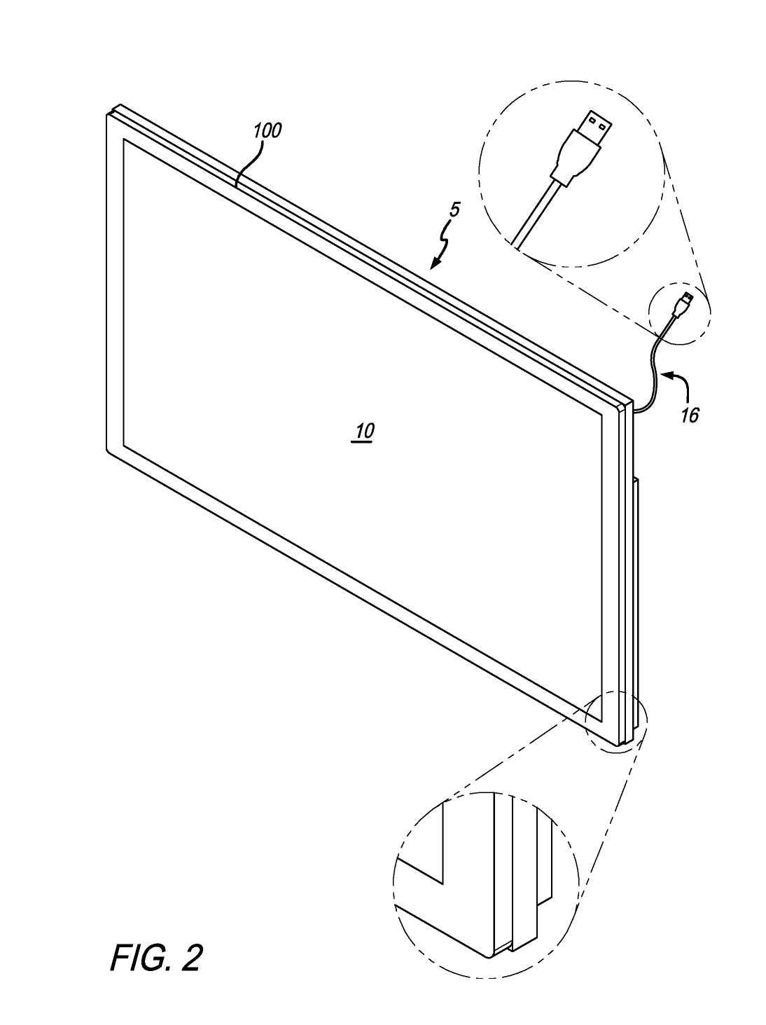

With reference to FIG. 2, a diagrammatic representation of the assembled bezel 100, with the PCAP touch glass 10 and monitor 5 is shown according to the embodiment of FIG. 1. The PCAP touch glass is shipped from the supplier with a USB cable 16 that is attachable to a controller or chip set for processing the input-output of the PCAP touch glass 10 and for providing power. In the past, the chip set normally would be inserted into a personal computer (PC), monitor assembly, or other closed container. The USB cable 16 would then be plugged into a USB port of the personal computer or processor, which then would produce output to the monitor through a VGA or HDMI interface. However, aftermarket integration of an existing monitor with the PCAP has been prevented or avoided because of the electronic data ribbon and chip configuration that is exposed from the PCAP touch glass 10.

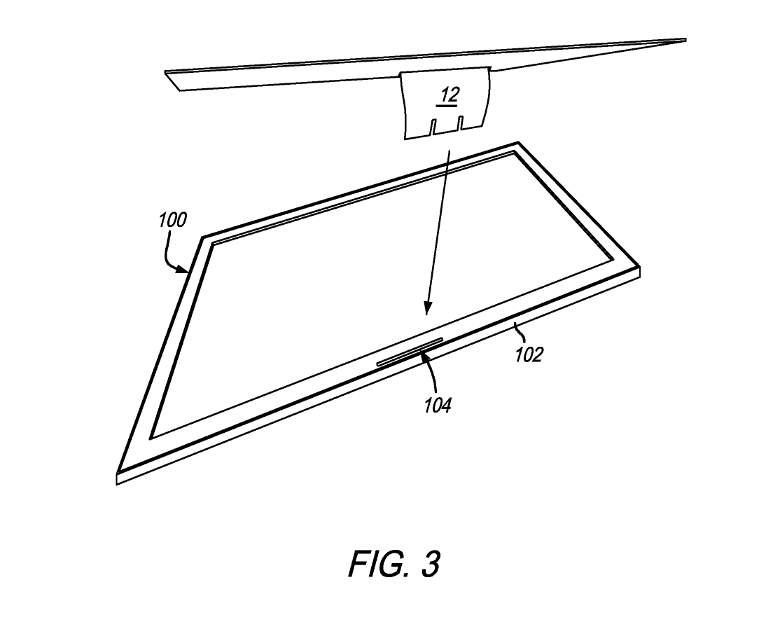

With reference to FIG. 3, a diagram illustrates the configuration of the touch glass 10 being attached to the bezel 100 according to one embodiment. As shown, the data ribbon 12 protrudes from the touch glass 10 as shipped from the manufacturer; a feature that normally prevents aftermarket attachment to an existing monitor 5. However, in one embodiment, during installation, the ribbon 12 is inserted through a slot 104 of the frame 102 of the bezel 100 from the front to the rear of the frame 102.

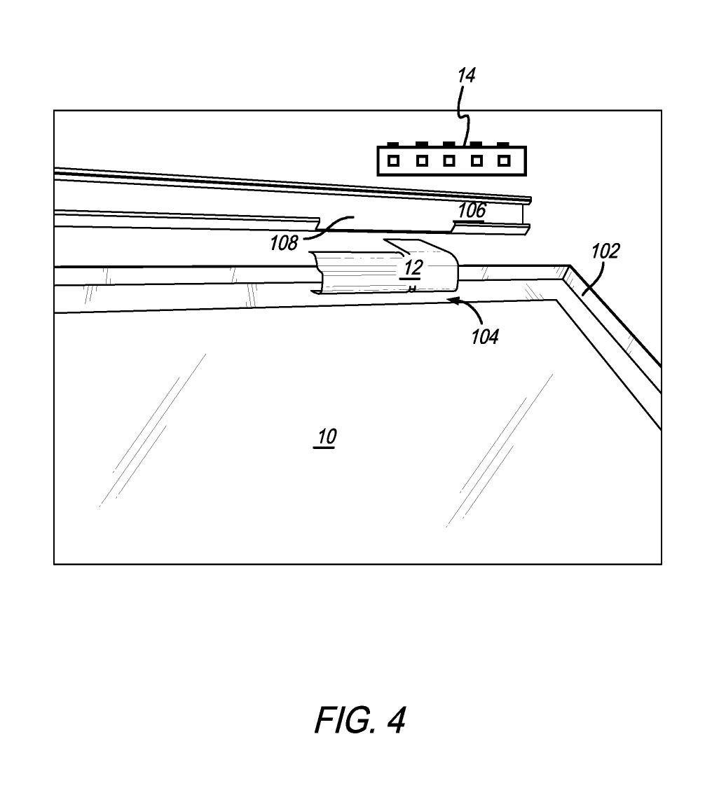

With reference to FIG. 4, a diagram illustrates a rear view of the frame with the PCAP touch glass 10 having been attached to the frame 102 of the bezel 100, with the ribbon 12 inserted through the slot 104. The controller or chipset 14 will attached to the distal end of the ribbon 12 after it has been inserted through the slot 104. A bottom monitor clamp bracket 106 attaches to the bottom of the frame 102, and contains a recess or cradle 108 having an opening in the bracket rail wherein the chipset 14 for the PCAP touch glass 10 may be attached or inserted.

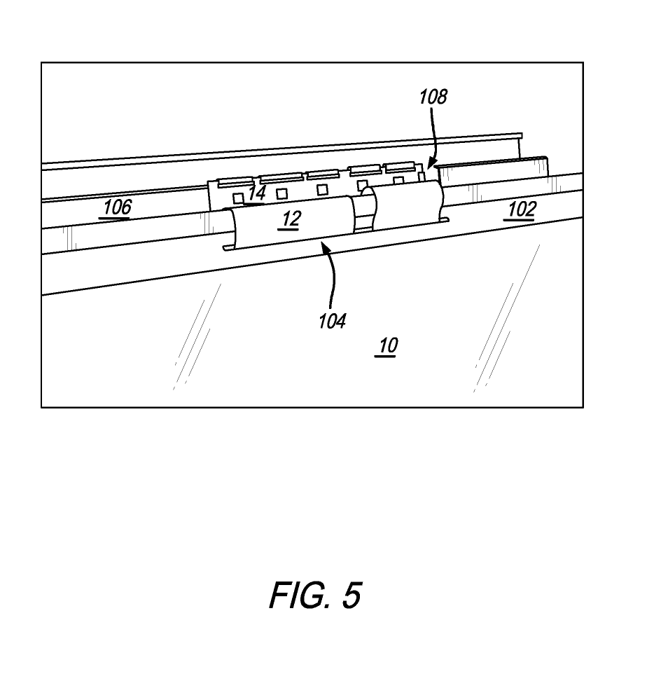

With reference to FIG. 5, a diagram illustrates another rear view of the frame with the chipset 14 inserted and attached into the cradle 108.

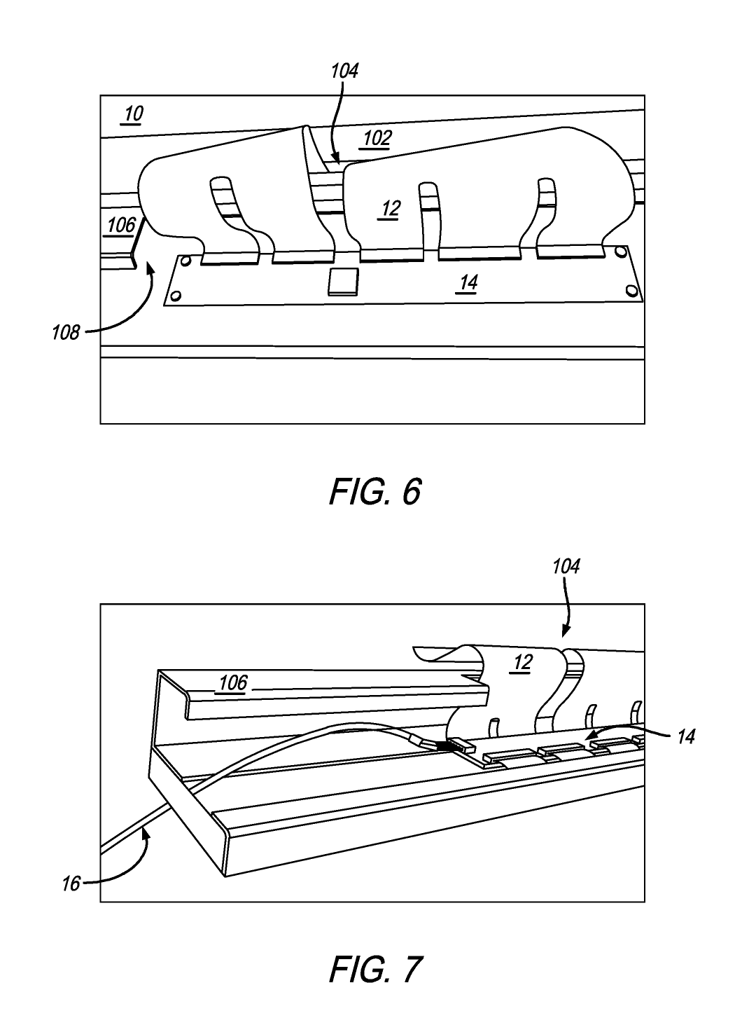

With reference to FIG. 6, a diagram illustrates a close up view of the chipset 14 now attached to the ribbon 12.

With reference to FIG. 7, a bottom perspective view of the clamp bracket 16 with the USB cable 16 attached to the controller or chipset 14 is shown. In one embodiment, the USB cable 16 may be threaded through a hole in the back of the clamp bracket 106 upon attachment to the controller or chipset 14.

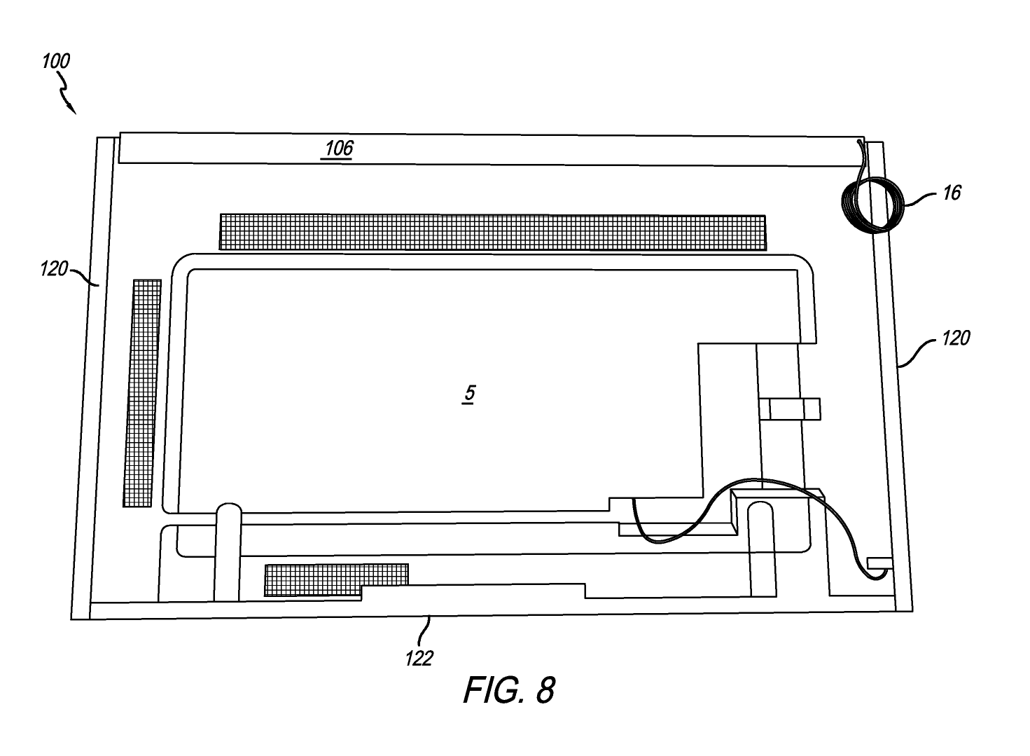

With reference to FIG. 8, a rear perspective view of the complete assembly of the bezel 100 is shown, with side clamps 120, bottom clamp 122, and the clamp bracket 106 enclosing the monitor 5.

The various embodiments described above are provided by way of illustration only and should not be construed to limit the invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed is:

1. A touchscreen panel bezel, comprising:
a frame configured to attached projected capacitive (PCAP) touchscreen panel;
one or more clamp brackets configured to secure a monitor within the frame;
a first one of said clamp brackets configured to receive and secure a universal serial bus (USB) controller;
a ribbon slot disposed within the frame configured to thread a ribbon of the PCAP touchscreen panel for attachment to the USB controller; and
a USB cable for attachment to the USB controller and a processer external to the bezel.

2. The touchscreen panel of claim 1, further comprising a second, third, and fourth clamp brackets to secure the monitor to the bezel.

3. The touchscreen panel bezel of claim 1, wherein the processor is a personal computer.

4. The touchscreen panel bezel of claim 3, wherein the processor is connected to the monitor to provide output to the monitor.

5. The touchscreen panel bezel of claim 4, wherein the PCAP panel is configured to provide input to the processor to control one or more applications.

6. A method for providing a touchscreen panel bezel, comprising:
attaching a projected capacitive (PCAP) touchscreen panel to frame;
securing one or more clamp brackets to the frame;
securing a universal serial bus (USB) controller to a first one of said clamp brackets;
threading a ribbon of the PCAP touchscreen through a slot disposed within the frame;
attaching the ribbon to the USB controller; and
attaching a USB cable to the USB controller and a processer external to the bezel.

7. The method of claim 6, further comprising securing the monitor to the bezel with a second, third, and fourth clamp bracket.

8. The method of claim 6, wherein the processor is a personal computer.

9. The method of claim 8, comprising connecting the processor to the monitor to provide output to the monitor.

10. The method of claim 9, wherein the PCAP panel is configured to provide input to the processor to control one or more applications.
